(19) United States
(12) Patent Application Publication
(10) Pub. No.: US 2025/0280022 A1
(43) Pub. Date: Sep. 4, 2025

(54) METHOD FOR DETECTING UNMANAGED CLOUD APPLICATIONS

(71) Applicant: Suridata.AI Ltd., Ramat Gan (IL)

(72) Inventors: Roi REICHART, Jerusalem (IL); Eran KOT-OFEK, London (GB); Oren VITMAN, Kiryat Ono (IL); Lev NIKOLAEVSKY, Ramat Gan (IL); Haviv OHAYON, Holon (IL)

(73) Assignee: Suridata.AI Ltd., Ramat Gan (IL)

(21) Appl. No.: 19/069,633

(22) Filed: Mar. 4, 2025

Related U.S. Application Data
(60) Provisional application No. 63/561,001, filed on Mar. 4, 2024.

(51) Int. Cl. H04L 9/40; H04L 41/16

(52) U.S. Cl. CPC H04L 63/1425; H04L 41/16; H04L 63/1433

(57) ABSTRACT

In some implementations, a system and method for detecting and analyzing unmanaged SaaS applications are provided. The method includes identifying at least one SaaS application based on a comparison of a set of SaaS application identifiers and entries in a SaaS application database; verifying, through analysis of user interactions, when the identified at least one SaaS application is unmanaged; and computing, using a trained supervised machine learning model, confidence scores of each unmanaged SaaS application, wherein a confidence score is a measure of certainty of the verification that a SaaS application is unmanaged.

### CROSS-REFERENCE TO RELATED APPLICATIONS

This application claims the benefit of U.S. Provisional Application No. 63/561,001 filed on Mar. 4, 2024, the contents of which are hereby incorporated by reference.

### TECHNICAL FIELD

The present disclosure generally relates to cybersecurity systems and, more particularly, to an incident response system.

### BACKGROUND

Software-as-a-Service (Saas) or cloud applications can be easily connected to the organization's network and resources by an organization's employees, used without IT or Security departments' approval, and used outside of the organizational perimeter. The following examples show deficiencies in the traditional approaches used to address organizations' security needs with regard to these unmanaged SaaS applications (also known as “shadow SaaS applications”.) Scanning an organization's emails for registration, passwords and payments to SaaS applications is intrusive and not accurate. Using procurement monitoring requires high maintenance. Employing a browser extension requires an agent to be installed on each end node in the organization. Using a web proxy requires inline products. Without full visibility, organizations cannot gain full risk analysis of each SaaS application and lack the control to decide whether to accept or reject an unsanctioned application.

It would, therefore, be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some aspects” or “certain aspects” may be used herein to refer to a single embodiment or multiple embodiments of the disclosure.

A method of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, the method may include identifying at least one SaaS application based on a comparison of a set of SaaS application identifiers and entries in a SaaS application database. The method may also include verifying, through analysis of user interactions, when the identified at least one SaaS application is unmanaged. The method may furthermore include computing, using a trained supervised machine learning model, confidence scores of each unmanaged SaaS application, where a confidence score is a measure of certainty of the verification that a SaaS application is unmanaged. Other embodiments of this aspect include corresponding computer systems, apparatus, and computer programs recorded on one or more computer storage devices, each configured to perform the actions of the methods.

Implementations may include one or more of the following features. The method where identifying an unmanaged SaaS application further may include: connecting to at least one security tool; retrieving traffic data from the at least one security tool, where traffic data includes logs; identifying meaningful user interactions with a suspected SaaS application, where a set of identifiers associated with each suspected SaaS application is identified; generating a key for the set of identifiers associated with each suspected SaaS application; and comparing each key to entries in a SaaS application database. The method where the at least one security tool is an Endpoint Detection and Response (EDR) system. The method where verifying whether the identified SaaS application is unmanaged further may include: enriching traffic data; calculating usage statistics for users over a pre-determined time period, where usage statistics include data about user interactions with SaaS applications; and comparing a selected user's interactions with the identified SaaS application to similar users' interactions with the identified SaaS application. The method where enriching traffic data further may include: generating a prompt for a generative AI (genAI) system, where the prompt includes at least traffic data and a prompt template; and executing the prompt, by the genAI system, to determine enrichment information relevant to the traffic data. The method may include: generating a list of identified unmanaged SaaS applications prioritized based on the computed confidence scores and security risk scores. The method where computing confidence scores using a trained supervised ML model further may include: collecting a dataset of traffic data, where the traffic data has associated metrics; determining at least one threshold for each metric based on predefined criteria; labeling traffic data of the dataset according to the determined at least one threshold, where the traffic data is assigned a label based on a value of the traffic data with respect to the determined at least on threshold of each metric; inputting the labeled traffic data of the dataset into a machine learning model; and training the machine learning model to compute confidence scores based on the labeled traffic data of the dataset, where the computation is determined by the value of the metric with respect to corresponding thresholds. The method where the SaaS application database includes a curated, up-to-date dataset of at least identifiers and traffic data associated with known SaaS applications. Implementations of the described techniques may include hardware, a method or process, or a computer tangible medium.

In one general aspect, non-transitory computer-readable medium may include one or more instructions that, when executed by one or more processors of a device, cause the device to: identify at least one SaaS application based on a comparison of a set of SaaS application identifiers and entries in a SaaS application database; verify, through analysis of user interactions, when the identified at least one SaaS application is unmanaged; and compute, using a trained supervised machine learning model, confidence scores of each unmanaged SaaS application, where a confidence score is a measure of certainty of the verification that a SaaS application is unmanaged. Other embodiments of this aspect include corresponding computer systems, apparatus, and computer programs recorded on one or more computer storage devices, each configured to perform the actions of the methods.

In one general aspect, the system may include one or more processors configured to: identify at least one SaaS application based on a comparison of a set of SaaS application identifiers and entries in a SaaS application database; verify, through analysis of user interactions, when the identified at least one SaaS application is unmanaged; compute, using a trained supervised machine learning model, confidence scores of each unmanaged SaaS application, where a confidence score is a measure of certainty of the verification that a SaaS application is unmanaged. Other embodiments of this aspect include corresponding computer systems, apparatus, and computer programs recorded on one or more computer storage devices, each configured to perform the actions of the methods.

Implementations may include one or more of the following features. The system where the one or more processors, when identifying an unmanaged SaaS application, are configured to: connect to at least one security tool; retrieve traffic data from the at least one security tool, where traffic data includes logs; identify meaningful user interactions with a suspected SaaS application, where a set of identifiers associated with each suspected SaaS application is identified; generate a key for the set of identifiers associated with each suspected SaaS application; and compare each key to entries in a SaaS application database. The system where the at least one security tool is an Endpoint Detection and Response (EDR) system. The system where the one or more processors, when verifying whether the identified SaaS application is unmanaged, are configured to: enrich traffic data; calculate usage statistics for users over a pre-determined time period, where usage statistics include data about user interactions with SaaS applications; and compare a selected user's interactions with the identified SaaS application to similar users' interactions with the identified SaaS application. The system where the one or more processors, when enriching traffic data, are configured to: generate a prompt for a generative AI (genAI) system, where the prompt includes at least traffic data and a prompt template; and execute the prompt, by the genAI system, to determine enrichment information relevant to the traffic data. The system where the one or more processors are further configured to: generate a list of identified unmanaged SaaS applications prioritized based on the computed confidence scores and security risk scores. The system where the one or more processors, when computing confidence scores using a trained supervised ML model, are configured to: collect a dataset of traffic data, where the traffic data has associated metrics; determine at least one threshold for each metric based on predefined criteria; labeling traffic data of the dataset according to the determined at least one threshold, where the traffic data is assigned a label based on a value of the traffic data with respect to the determined at least on threshold of each metric; inputting the labeled traffic data of the dataset into a machine learning model; and training the machine learning model to compute confidence scores based on the labeled traffic data of the dataset, where the computation is determined by the value of the metric with respect to corresponding thresholds. The system where the SaaS application database includes a curated, up-to-date dataset of at least identifiers and traffic data associated with known SaaS applications. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 shows an example network diagram utilized to describe the various disclosed embodiments.

FIG. 2 shows an example flowchart for detecting and analyzing unmanaged SaaS applications according to an embodiment.

FIG. 3 shows an example flowchart of a process for identifying unmanaged SaaS applications according to an embodiment.

FIG. 4 shows an example flowchart of a process for verifying that identified SaaS applications are unmanaged SaaS applications according to an embodiment.

FIG. 5 is an example schematic diagram of a system according to an embodiment.

### DETAILED DESCRIPTION

It is important to note that the embodiments disclosed herein are only examples of the many advantageous uses of the innovative teachings disclosed herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

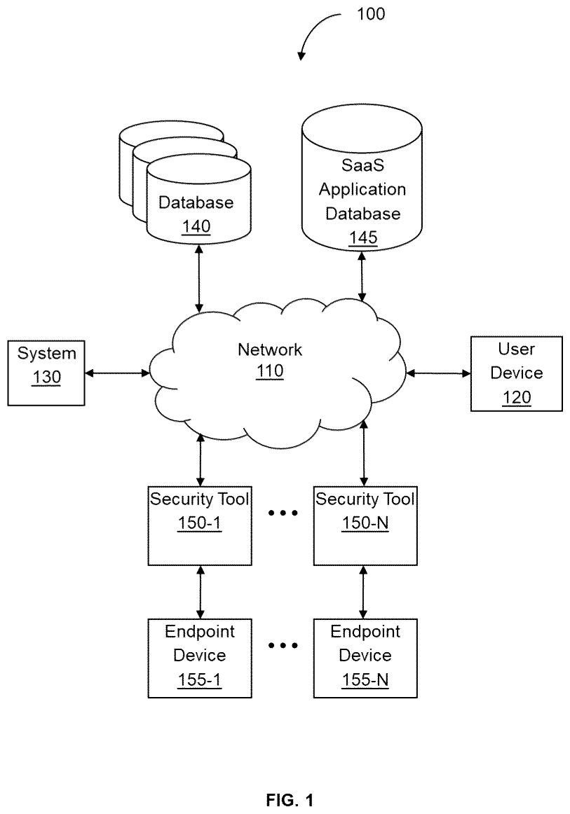

FIG. 1 shows an example network diagram 100 utilized to describe the various disclosed embodiments. In the example network diagram 100, a user device 120, a system 130, security tools 150-1 through 150-N (hereinafter referred to individually as a security tool 150 and collectively as security tools 150, merely for simplicity purposes), endpoint devices 155-1 through 155-N (hereinafter referred to individually as an endpoint device 155 and collectively as endpoint devices 155, merely for simplicity purposes), and a plurality of databases 140-1 through 140-N (hereinafter referred to individually as a database 140 and collectively as databases 140, merely for simplicity purposes) communicate via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The user device (UD) 120 is a device used by a security team of an organization to manage the security systems of that organization. The UD 120 may be, but is not limited to, a personal computer, a laptop, a tablet computer, a smartphone, a wearable computing device, or any other device capable of receiving and displaying notifications. The UD 120 may access the system 130 via the network 110. The system 130 may output results of the operations of the system 130 to the UD 120.

Security tools 150 may be any one of a variety of security tools including, but not limited to, endpoint protection tools (e.g., Endpoint Detection and Response system) connected to (or installed as agents on) the endpoint devices 155. The security tools 150 are configured to monitor network communication in and out of the organization, including communication to and from endpoint devices 155 and various SaaS services, including, but not limited to, SaaS applications hosted on one or more databases 140. Although databases 140 are shown, it should be noted that security tools 150 are not limited to monitoring network traffic between endpoint devices 155 and SaaS resources hosted on databases 140. Databases 140 may be, but are not limited to, cloud services that host SaaS applications. Endpoint devices 155 include any devices that connect to a network (e.g., network 110) and serve as entry points for data exchange, including, but not limited to, resources hosted on databases 140, between users in an organization. In an embodiment, the security tools 150 monitor HTTP and HTTP/S communication and record logs of the communication events.

The system 130 connects to the security tools 150 and is configured to analyze the logs collected by the security tools 150. Analysis of the logs includes identifying URLs, IP addresses, and other identifiers recorded in the logs that reflect the network communication events. The system 130 analyzes the identifiers associated with the communication events (e.g., requests or access by an endpoint device 155) involving various resources that are suspected to be SaaS applications. In an embodiment, the identifiers are compared to identifiers associated with known SaaS applications to determine the precise identity of the suspected SaaS applications. According to this embodiment, known SaaS applications may be stored in a database, such as SaaS Application Database 145, or retrieved from third-party sources.

In an embodiment, SaaS Application Database 145 is a database that stores a curated dataset including identifiers and other information related to known SaaS applications.

The system 130 also provides enriched data related to the communication events with the suspected SaaS applications to corroborate whether the suspected SaaS application is an unmanaged SaaS application. This corroboration includes analysis of the patterns of usage of the suspected SaaS applications as well as a comparison of usage across users in an organization to determine whether the SaaS application is an unmanaged SaaS application. An unmanaged SaaS application is defined as an application that is utilized by the users in an organization in an intentional way for work purposes and that the organization's security team is not aware of. A managed application means that the security team is aware of the use of the SaaS application in the organization and, in some cases, knows which users are using the applications. Verifying an unmanaged SaaS application includes an analysis of whether a user interaction with a SaaS application that is not monitored by the security team is intentional. If a user interaction with a SaaS application is unintentional, for example if a user unintentionally interacts with a SaaS application by inadvertently navigating (e.g., through a banner ad) to a SaaS application (e.g., DropBox®), that SaaS application is not considered an unmanaged application. The system 130 is configured to determine which interactions are intentional and which are unintentional.

In an embodiment, enrichment of the data is performed using various machine learning techniques. The ML techniques may be performed by a generative AI (genAI) system including, but not limited to, a Large Language Model (LLM). The genAI system is configured to determine enrichment information related to the traffic data such as, but not limited to, a type of SaaS application (e.g., social, CRM, analytics, etc.). For example, a prompt is generated for a genAI system. The prompt may include, but is not limited to, traffic data and a prompt template. The genAI system executes the prompt and determines the enrichment information relevant to the traffic data.

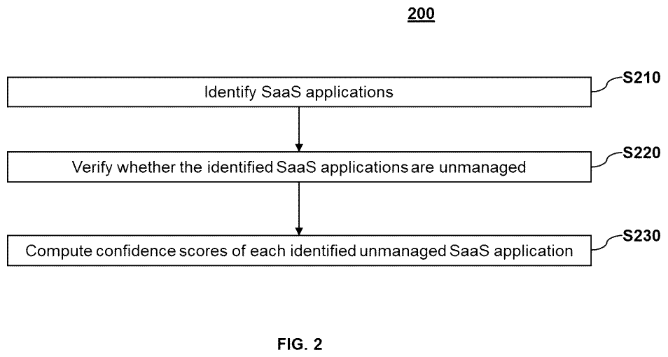

The disclosed embodiments include computing confidence scores that measure the certainty with which a SaaS application is verified as an unmanaged SaaS application. Various machine learning (ML) techniques (discussed in more detail with respect to FIG. 2), including supervised ML techniques, are used to compute confidence scores (defined below) that correlate to security risk of SaaS applications.

Computed confidence scores are used to generate a prioritized list of SaaS applications for security teams, enabling the security teams to gain greater visibility into all the SaaS applications that are unmanaged. The prioritized list allows the security team to identify which unmanaged SaaS applications pose the highest risk to the organization, which enables the security team to perform some mitigation action, such as, not limited to, blocking the SaaS application or uninstalling the SaaS application from an endpoint device.

FIG. 2 shows an example flowchart 200 for detecting and analyzing unmanaged SaaS applications, according to an embodiment. In an embodiment, the detection and analysis are performed by the system 130.

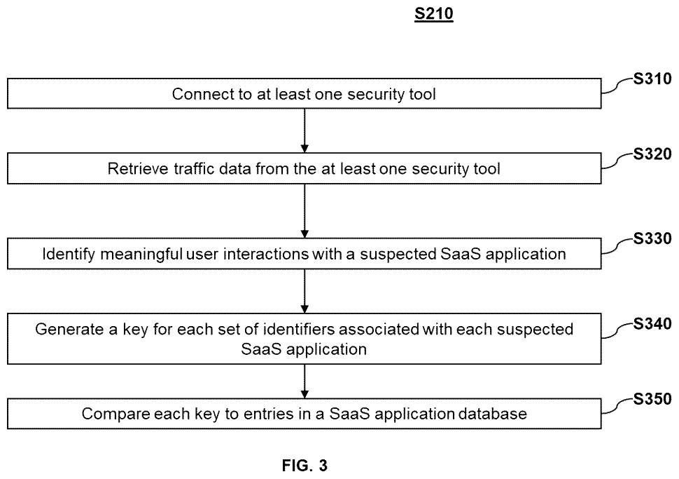

At S210, SaaS applications are identified. Identifying SaaS applications involves the analysis of logs that contain URLs, IP addresses, and other identifiers that reflect network communication events. The communication events may be, but are not limited to, requests or access by an endpoint device 155 for a SaaS service. In an embodiment, the identifiers are compared to identifiers associated with known SaaS applications to determine the identity of suspected SaaS applications. According to this embodiment, known SaaS applications may be stored in a database (e.g., SaaS Application Database 145) or retrieved from third-party sources. Identifying SaaS applications is discussed in greater detail with respect to FIG. 3.

In an embodiment, artificial intelligence (AI) techniques are used to accurately identify the associated SaaS application based on a comparison with SaaS applications stored in a database. The database may contain, but is not limited to, enriched data about the application, including the purpose and category of the application, information on the provider, intended users, and security information.

At S220, it is verified whether the identified SaaS applications are unmanaged. Unmanaged SaaS applications, as defined and discussed above, are determined. This determination involves discerning, based on analysis of patterns of a user and patterns across multiple users with a SaaS application, between interactions with SaaS applications that are intentional and unintentional. Filtering out SaaS applications that are unintentionally accessed or interacted with serves to reduce the false positive detection rate.

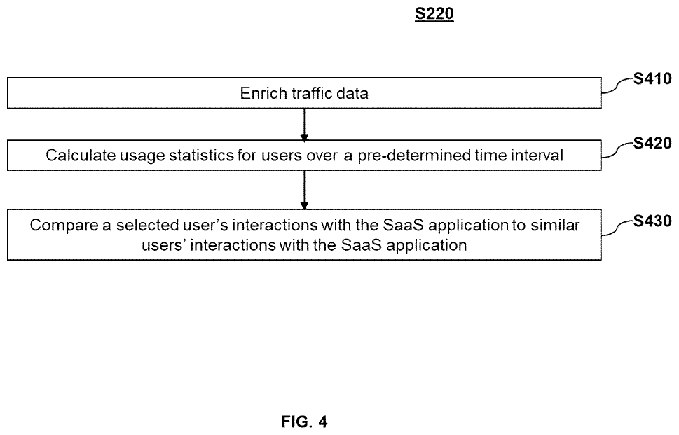

Verification of identified unmanaged SaaS applications is discussed in greater detail with respect to FIG. 4.

At S230, the confidence score of each identified unmanaged SaaS application is computed. A confidence score is a measure of the level of certainty of the verification that an identified SaaS application is an unmanaged SaaS application.

As a non-limiting example, if a user on an endpoint device is browsing the web and opens a news web page. In the background of the user interaction with the web page, the user may be sent to an advertisement site that produces and displays an advertisement on the screen of the endpoint device. This interaction, as well as any other user interactions with that advertisement page, will generate a log of a network communication associated with each respective endpoint device. Whether a particular user's interaction with that website is an intentional interaction with an unmanaged SaaS application may be determined, by the supervised ML model, based on the above features that the model was trained to analyze.

In an embodiment, as mentioned above, computing confidence scores may involve the use of a custom-trained supervised ML model. The model is trained to compute confidence scores based on a number of features of traffic data and information about applications. Features include, but are not limited to, to the following: the number of distinct individuals who have interacted with the application during a specific time period; the frequency of interactions with an application per individual user; the total number of interactions with an application amongst all users in an organization; the percentage of distinct users in relation to a base number of users; whether the name of the organization appears anywhere in the URL, or specifically within the domain or subdomain part; the percentage of distinct users who have logged in to an application (login event); the overall number of interactions during login event; the total number of users who initiated a login; the number of login events where client-specific information is present in the URL; the total number of users, whether active or not, over a period of time; the earliest and most recent instances of user activity; a specific time window for scanning or analyzing user activity; the confidence score of login events (measuring certainty that the event is an intentional login event); the type of the organization using an application; the size of the organization; the specific uses of an application within the organization; whether an application is being used as a SaaS application; the level of usage of the application among different organizations; a score of how certain an application belongs in a specific category; encoded information about the organization's type; and encoded information about the professional roles within the organization.

These features are labeled and used to train a machine learning model to compute a confidence score that the features indicate that a user interaction with an application is an intentional interaction with an unmanaged SaaS application. Computing the confidence scores for each unmanaged SaaS application using such ML techniques allows for the accurate determination of security risk associated with each such application.

Security risk of a SaaS application is a measurement of the potential for unauthorized access, data breaches, or other security incidents that could compromise the confidentiality, integrity, or availability of data and services hosted on the SaaS application. Scoring security risk of the SaaS application is based on factors including, but not limited to, the computed confidence scores, details about the SaaS application, details about the users accessing the SaaS application, and the security history of the SaaS application (e.g., whether there has been a security breach associated with a SaaS application). A SaaS application that has a high confidence of being an unmanaged SaaS application is one factor that indicates that the unmanaged application has a high security risk.

In an embodiment, scoring the security risk of each SaaS application allows for generating a list of identified unmanaged SaaS applications prioritized based on the security risk scores. Generating the list of prioritized SaaS applications enables a security team of the organization to gain greater visibility into all the SaaS applications that are both managed and unmanaged. The prioritized list allows the security team to identify which unmanaged SaaS applications pose the highest risk to the organization, which enables the security team to perform some mitigation action, such as, not limited to, blocking the SaaS application or uninstalling the SaaS application from an endpoint device.

FIG. 3 shows an example flowchart S210 of a process for identifying unmanaged SaaS applications. In an embodiment, the process for identifying unmanaged SaaS applications is performed by the system 130.

At S310, at least one security tool is connected to. In an embodiment, security tools may be security tools 150, FIG. 1. In an embodiment, the security tool may be an endpoint detection and response (EDR) system. In another embodiment, the security tool is connected to via Application Programming Interface (API) tokens. API tokens are unique identifiers used to authenticate and authorize access to an API.

At S320, traffic data is received from the at least one security tool. In an embodiment, the traffic data is collected in logs by the at least one security tool from endpoint devices.

The received traffic data includes logs that contain URLs, IP addresses, and other identifiers that reflect network communication events. The communication events may be, but are not limited to, requests or access by an endpoint device 155 for a resource hosted in a server (e.g., database 150).

At S330, meaningful user interactions with a suspected SaaS application are identified. In an embodiment, a meaningful user interaction with a suspect SaaS application may be an intentional interaction from an endpoint device with an IP address or other identifier that is associated with a SaaS application. Identifying user interactions with SaaS applications that are meaningful serves to filter out interactions with SaaS applications that are not meaningful. For an interaction to not be meaningful, the traffic data generated by that interaction may reflect that the interaction was unintentional based on, but not limited to, the amount of requests to a SaaS application and the type of communication events. Filtering such interactions out serves to identify the SaaS applications that reflect a user's intentional interaction with the SaaS application as opposed to the multitude of unintentional interactions generated by many endpoint devices. Identifying meaningful interactions serves to identify which applications, when unmanaged by a security team, present a significant security risk to the organization.

At S340, a key is generated for each set of identifiers associated with each suspected SaaS application. Transforming the set of identifiers such as, but not limited to, URLs and other enriched information associated with the suspected SaaS application into a key allows a unique identifier to be associated with the suspected SaaS application. This key enables the comparison with entries in a SaaS application database to identify SaaS applications.

At S350, each key is compared to entries in a SaaS application database. In an embodiment, the database may be SaaS Application Database 145, FIG. 1. As discussed above, the SaaS application database may include information about SaaS applications including, but not limited to, their purpose and category of service as well as a security history. As discussed above, in an embodiment, AI techniques may be used to perform this comparison, allowing the precise identification of the suspected SaaS application.

In an embodiment, the identifiers are compared to identifiers associated with known SaaS applications to determine the identity of one or more suspected SaaS applications.

FIG. 4 shows an example flowchart S220 of a process for verifying that identified SaaS applications are unmanaged SaaS applications. In an embodiment, the process for verifying unmanaged SaaS applications is performed by system 130.

At S410, traffic data is enriched. Enriching traffic data includes creating a detailed dataset regarding the number and type of interactions from all endpoint devices, shown by traffic data, with IP addresses associated with an identified SaaS application.

At S420, usage statistics for users over a pre-determined time interval are calculated.

In another embodiment, usage statistics are calculated based on enriched traffic data associated with interactions with SaaS applications collected per user over a pre-determined time interval. Usage analysis involves assessing user interactions with the application, measuring user behavior, and assessing risks based not only on the type of applications but also on their specific usage within the organization's network.

At S430, a selected user's interactions with the identified SaaS application are compared to other users' interactions with the identified SaaS application.

In one embodiment, the user analysis may include identifying a selected user of an endpoint device that interacts with a SaaS application and comparing the interactions of that selected user with interactions of other similar users in the organization. This comparative user analysis allows the verification that a particular SaaS application is unmanaged based on anomalies in the interactions by one user compared to others.

For example, if it is detected that a single user, through an endpoint device, has a prolonged interaction (as indicated by a sufficiently high number of interactions, e.g., HTML requests) with a SaaS application that is not regularly accessed by similar users in the organization over a pre-determined time interval, this may indicate that the SaaS application is unmanaged.

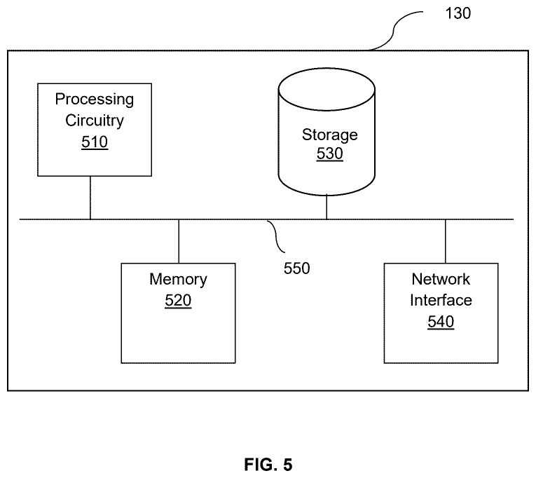

FIG. 5 is an example schematic diagram of a system 130 according to an embodiment. The system 130 includes a processing circuitry 510 coupled to a memory 520, a storage 530, and a network interface 540. In an embodiment, the components of the system 130 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

In at least some embodiments, the processing circuitry 510 is configured to execute generative artificial intelligence (genAI) models, perform inference using or otherwise apply genAI models, train genAI models, fine-tune genAI models, combinations thereof, and the like. Such genAI models are configured to produce text, images, videos, or other forms of data, and may include, but are not limited to, language models (for example, but not limited to, large language models, small language models, etc.), text-to-image artificial intelligence (AI) image generation systems, text-to-video AI video generators, combinations thereof, and the like. To this end, the processing circuitry 510 may be adapted to realize a transformer deep learning architecture (e.g., a generative pre-trained transformer [GPT], bidirectional encoder representations from transformers [BERT], text-to-text transfer transformer [T5], etc.), a diffusion model, both, and the like.

In accordance with various such embodiments, the hardware utilized for the processing circuitry 510 is selected in order to enable genAI functionality based on factors such as, but not limited to, parallelism (e.g., amounts of parallel processing to be performed), memory demands (e.g., amounts of random access memory [RAM] utilized to store model weights and training during processing or video RAM [VRAM] to support large language models), clock speeds, thread counts, storage (for example, to support certain amounts of storage or storage speeds), cooling (e.g., liquid cooling or air cooling systems), power supply (e.g., in order to enable a target wattage used for certain kinds of activities), networking and connectivity (e.g., in order to support seamless data transfer for deployments involving communications between or among multiple machines or clusters), combinations thereof, and the like.

In embodiments that utilize large language models (LLMs) or otherwise perform operations that may require or be enhanced through the use of parallel processing, the processing circuitry 510 may include one or more GPUs or other processing units suitable for parallel processing. Such GPUs may be configured to perform matrix multiplication operations including, but not limited to, performing dot product operations in order to support neural network operations (for example, by performing dot product operations for hidden layer computations) or performing dot product operations in an attention mechanism in order to compute a similarity score between vectors during attention weight computation. In at least some such embodiments using GPUs, the processing circuitry 510 may include a number of CPU cores which is equal to or greater than the number of GPUs in order to facilitate or otherwise support parallel processing via multiple GPUs.

The memory 520 may be volatile (e.g., random access memory, etc.), non-volatile (e.g., read-only memory, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

It should be understood that the embodiments described herein are not limited to the specific architecture illustrated in FIG. 5, and other architectures may be equally used without departing from the scope of the disclosed embodiments.

It is important to note that the embodiments disclosed herein are only examples of the many advantageous uses of the innovative teachings disclosed herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform, such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for detecting and analyzing unmanaged SaaS applications, comprising:
identifying at least one SaaS application based on a comparison of a set of SaaS application identifiers and entries in a SaaS application database;
verifying, through analysis of user interactions, when the identified at least one SaaS application is unmanaged; and
computing, using a trained supervised machine learning model, confidence scores of each unmanaged SaaS application, wherein a confidence score is a measure of certainty of the verification that a SaaS application is unmanaged.

2. The method of claim 1, wherein identifying an unmanaged SaaS application further comprises:
connecting to at least one security tool;
retrieving traffic data from the at least one security tool, wherein traffic data includes logs;
identifying meaningful user interactions with a suspected SaaS application, wherein a set of identifiers associated with each suspected SaaS application is identified;
generating a key for the set of identifiers associated with each suspected SaaS application; and
comparing each key to entries in a SaaS application database.

3. The method of claim 1, wherein verifying whether the identified SaaS application is unmanaged further comprises:
enriching traffic data;
calculating usage statistics for users over a pre-determined time period, wherein usage statistics include data about user interactions with SaaS applications; and
comparing a selected user's interactions with the identified SaaS application to similar users' interactions with the identified SaaS application.

4. The method of claim 1, further comprising:
generating a list of identified unmanaged SaaS applications prioritized based on the computed confidence scores and security risk scores.

5. The method of claim 1, wherein computing confidence scores using a trained supervised ML model further comprises:
collecting a dataset of traffic data, wherein the traffic data has associated metrics;
determining at least one threshold for each metric based on predefined criteria;
labeling traffic data of the dataset according to the determined at least one threshold, wherein the traffic data is assigned a label based on a value of the traffic data with respect to the determined at least on threshold of each metric;
inputting the labeled traffic data of the dataset into a machine learning model; and
training the machine learning model to compute confidence scores based on the labeled traffic data of the dataset, wherein the computation is determined by the value of the metric with respect to corresponding thresholds.

6. The method of claim 2, wherein the at least one security tool is an Endpoint Detection and Response (EDR) system.

7. The method of claim 3, wherein enriching traffic data further comprises:
generating a prompt for a generative AI (genAI) system, wherein the prompt includes at least traffic data and a prompt template; and
executing the prompt, by the genAI system, to determine enrichment information relevant to the traffic data.

8. The method of claim 1, wherein the SaaS application database includes a curated, up-to-date dataset of at least identifiers and traffic data associated with known SaaS applications.

9. A non-transitory computer-readable medium storing a set of instructions for detecting and analyzing unmanaged SaaS applications, the set of instructions comprising:
one or more instructions that, when executed by one or more processors of a device, cause the device to:
identify at least one SaaS application based on a comparison of a set of SaaS application identifiers and entries in a SaaS application database;
verify, through analysis of user interactions, when the identified at least one SaaS application is unmanaged; and
compute, using a trained supervised machine learning model, confidence scores of each unmanaged SaaS application, wherein a confidence score is a measure of certainty of the verification that a SaaS application is unmanaged.

10. A system for detecting and analyzing unmanaged SaaS applications comprising:
one or more processors configured to:
identify at least one SaaS application based on a comparison of a set of SaaS application identifiers and entries in a SaaS application database;
verify, through analysis of user interactions, when the identified at least one SaaS application is unmanaged; and
compute, using a trained supervised machine learning model, confidence scores of each unmanaged SaaS application, wherein a confidence score is a measure of certainty of the verification that a SaaS application is unmanaged.

11. The system of claim 10, wherein the one or more processors, when identifying an unmanaged SaaS application, are configured to:
connect to at least one security tool;
retrieve traffic data from the at least one security tool, wherein traffic data includes logs;
identify meaningful user interactions with a suspected SaaS application, wherein a set of identifiers associated with each suspected SaaS application is identified;
generate a key for the set of identifiers associated with each suspected SaaS application; and
compare each key to entries in a SaaS application database.

12. The system of claim 11, wherein the at least one security tool is an Endpoint Detection and Response (EDR) system.

13. The system of claim 10, wherein the one or more processors, when verifying whether the identified SaaS application is unmanaged, are configured to:
enrich traffic data;
calculate usage statistics for users over a pre-determined time period, wherein usage statistics include data about user interactions with SaaS applications; and
compare a selected user's interactions with the identified SaaS application to similar users' interactions with the identified SaaS application.

14. The system of claim 13, wherein the one or more processors, when enriching traffic data, are configured to:
generate a prompt for a generative AI (genAI) system, wherein the prompt includes at least traffic data and a prompt template; and
execute the prompt, by the genAI system, to determine enrichment information relevant to the traffic data.

15. The system of claim 10, wherein the one or more processors are further configured to:
generate a list of identified unmanaged SaaS applications prioritized based on the computed confidence scores and security risk scores.

16. The system of claim 10, wherein the one or more processors, when computing confidence scores using a trained supervised ML model, are configured to:
collect a dataset of traffic data, wherein the traffic data has associated metrics;
determine at least one threshold for each metric based on predefined criteria;
label traffic data of the dataset according to the determined at least one threshold, wherein the traffic data is assigned a label based on a value of the traffic data with respect to the determined at least one threshold of each metric;
input the labeled traffic data of the dataset into a machine learning model; and
train the machine learning model to compute confidence scores based on the labeled traffic data of the dataset, wherein the computation is determined by the value of the metric with respect to corresponding thresholds.

17. The system of claim 10, wherein the SaaS application database includes a curated, up-to-date dataset of at least identifiers and traffic data associated with known SaaS applications.
